(19) United States
(12) Patent Application Publication
(10) Pub. No.: US 2011/0103376 A1
(43) Pub. Date: May 5, 2011

(54) TELEPHONE SYSTEM AND EXCHANGE APPARATUS FOR USE IN THE SAME

(76) Inventor: Hideaki Nakai, Hino-shi (JP)

(21) Appl. No.: 12/908,713

(22) Filed: Oct. 20, 2010

(30) Foreign Application Priority Data
Oct. 30, 2009 (JP) 2009-251173

(51) Int. Cl. H04L 12/66

(52) U.S. Cl. 370/352

(57) ABSTRACT

According to one embodiment, a telephone system includes an exchange apparatus and a media server. The exchange apparatus include a detector and a controller. The detector detects an amount of resources remaining in the media server of the node including the exchange apparatus. The controller transmits a tone signal to a telephone terminal of a calling node from the resources available in the media server of the node including the exchange apparatus, which is a called node, in response to a call connection request made from the calling node to the exchange apparatus if the amount of resources remaining in the media server of the called node exceeds a prescribed threshold value.

### CROSS-REFERENCE TO RELATED APPLICATIONS

This application is based upon and claims the benefit of priority from Japanese Patent Application No. 2009-251173, filed Oct. 30, 2009; the entire contents of which are incorporated herein by reference.

### FIELD

Embodiment described herein relate generally to a telephone system including a media server and an exchange apparatus for use in the telephone system.

### BACKGROUND

Some of the telephone systems using the Internet protocol (IP) network provide various kinds of service that uses media servers in connection with audio communication. A media server is connected to the exchange apparatus of any telephone system of this type, performing auxiliary functions for the exchange apparatus. The exchange apparatus performs fundamental functions related to exchanges and connections, such as the switching of lines. The media server generates audio or tone signals, such as busy tone, and transmits the audio or tone signals to the calling side.

Most systems practically used are of the type that are connect a plurality of local area networks (LANs), each having IP telephones, IP exchanges and media servers, to one another, through a network system of IP-dedicated lines. The system uses the resources (e.g., circuits for generating sound or tone signals, and ports) of a media server, thereby providing various kinds of service in response to calls and various requests made at the IP telephone sets. Inevitably, the media server must have many resources (e.g., communication ports in sufficient numbers). This may likely raise the resource cost.

A technique related is available. This technique controls a call control server in response to presence data or call-control setting condition data, achieving a call control in accordance with the user conditions, without bothering both the calling user and the called user. (See Jpn. Pat. Appln. KOKAI Publication No. 2008-28770.)

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is a system diagram showing a telephone system according to a first embodiment;

FIG. 2 is a sequence diagram showing the sequence performed when resources are abundant at a called node call, in order to request for resources available in a media server of the first embodiment;

FIG. 3 is a sequence diagram showing the sequence performed when resources are scarce at the node receiving a call, in order to request for resources available in a media server of a second embodiment;

FIG. 4 is a diagram showing exemplary contents that may be registered in a terminal data control table;

FIG. 5 is a sequence diagram showing the sequence performed when resources are scarce at the node receiving a call, if the calling IP telephone has the function of transmitting a tone signal; and

FIG. 6 is a sequence diagram showing a different sequence that may be performed when resources are scarce at the node receiving a call, if the calling IP telephone has the function of transmitting a tone signal.

### DETAILED DESCRIPTION

Various embodiments will be described hereinafter with reference to the accompanying drawings, in general, according to one embodiment, a telephone system includes an exchange apparatus and a media server. The exchange apparatus include a detector and a controller. The detector detects an amount of resources remaining in the media server of the node including the exchange apparatus. The controller transmits a tone signal to a telephone terminal of a calling node from the resources available in the media server of the node including the exchange apparatus, which is a called node, in response to a call connection request made from the calling node to the exchange apparatus if the amount of resources remaining in the media server of the called node exceeds a prescribed threshold value.

### First Embodiment

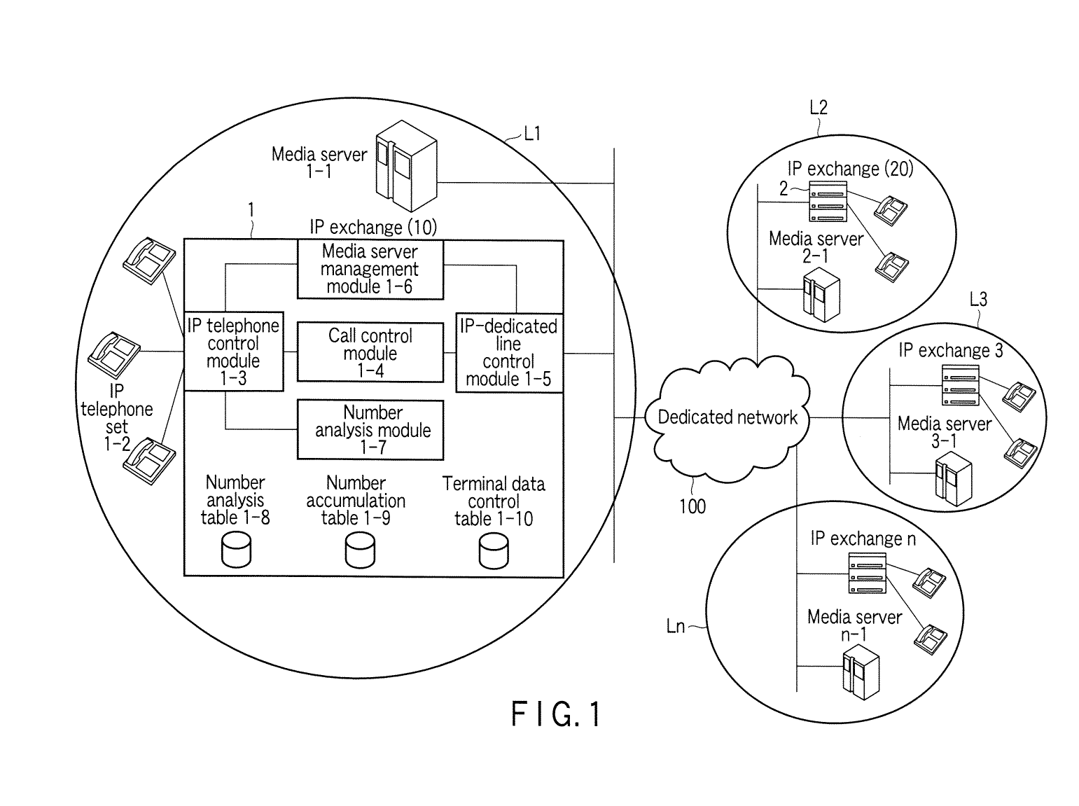

FIG. 1 is a system diagram showing a telephone system according to a first embodiment. The system is composed of a plurality of local area networks (LANs) L1 to Ln, each having a media server and an IP exchange apparatus, and a dedicated network 100 that connects the local area networks L1 to Ln. The networks L1 to Ln are called “nodes.”

An IP exchange apparatus is provided in each LAN and incorporates a plurality of telephone sets. Further, a media server is connected to each IP exchange apparatus and can supply hold signals and various service tones to the IP telephone sets.

In the LAN L1, for example, an IP exchange apparatus 1 and a media server 1-1 are connected to each other. The IP exchange apparatus 1 incorporates IP telephone set 1-2. Not only three IP telephone sets as shown in FIG. 1, but far more IP telephone set 1-2 can, of course, be incorporated in the IP exchange apparatus 1. The other LANs L2 to Ln are similar in configuration to the LAN L1.

The IP exchange apparatus 1 includes an IP telephone control module 1-3, a call control module 1-4, an IP-dedicated line control module 1-5, a media server management module 1-6, a number analysis module 1-7, a number analysis table 1-8, a number accumulation table 1-9, and a terminal data control table 1-10.

The IP telephone control module 1-3 is connected to the IP telephone sets and controls the transmission and reception of a call control message to and from the IP telephone sets. The number analysis module 1-7 refers to the number analysis table 1-8 and analyzes the input number contained in the transmission request coming from the IP telephone control module 1-3. The result of analysis is notified to the IP telephone control module 1-3. If the result of analysis shows that an IP telephone set of any other LAN is requesting for transmission to an IP telephone set of any other LAN, the call control module 1-4 controls the calls in the IP exchange apparatus 1. The IP-dedicated line control module 1-5 transmits and receives various call control messages to and from the other node (i.e., LAN) incorporating the IP telephone set that should receive a call. The media server management module 1-6 manages the state of using the resource-use available in the media server, determining, particularly, whether resources remain in the media server.

The number analysis module 1-7 further refers to the number analysis module 1-8 and analyzes the input dial number coming from an IP telephone set. The number analysis table 1-8 is a table that holds the relationship between dial numbers and functions requested. The number accumulation table 1-9 temporarily holds the dial numbers input at the respective IP telephone sets. More precisely, the number accumulation table 1-9 stores the latest dial numbers input at the IP telephone sets.

The terminal data control table 1-10 is a table, in which the terminal IDs (IP addresses or media access control (MAC) addresses, or the like), extension numbers thereof, presence/absence of tone transmission function and types of transmittable dial signals are registered for the respective IP telephone sets.

As shown in FIG. 1, calls may be transmitted between the LANs via the network of IP-dedicated lines. In this case, to utilize the resource of a media server it is necessary to determine which media server should be used, the media server (i.e., calling node) provided in the LAN that has the calling IP terminal or the media server (i.e., called node) provided in the LAN that has the called IP telephone set. In this embodiment, the media server that is the called node is used so long as it is abundant in resources.

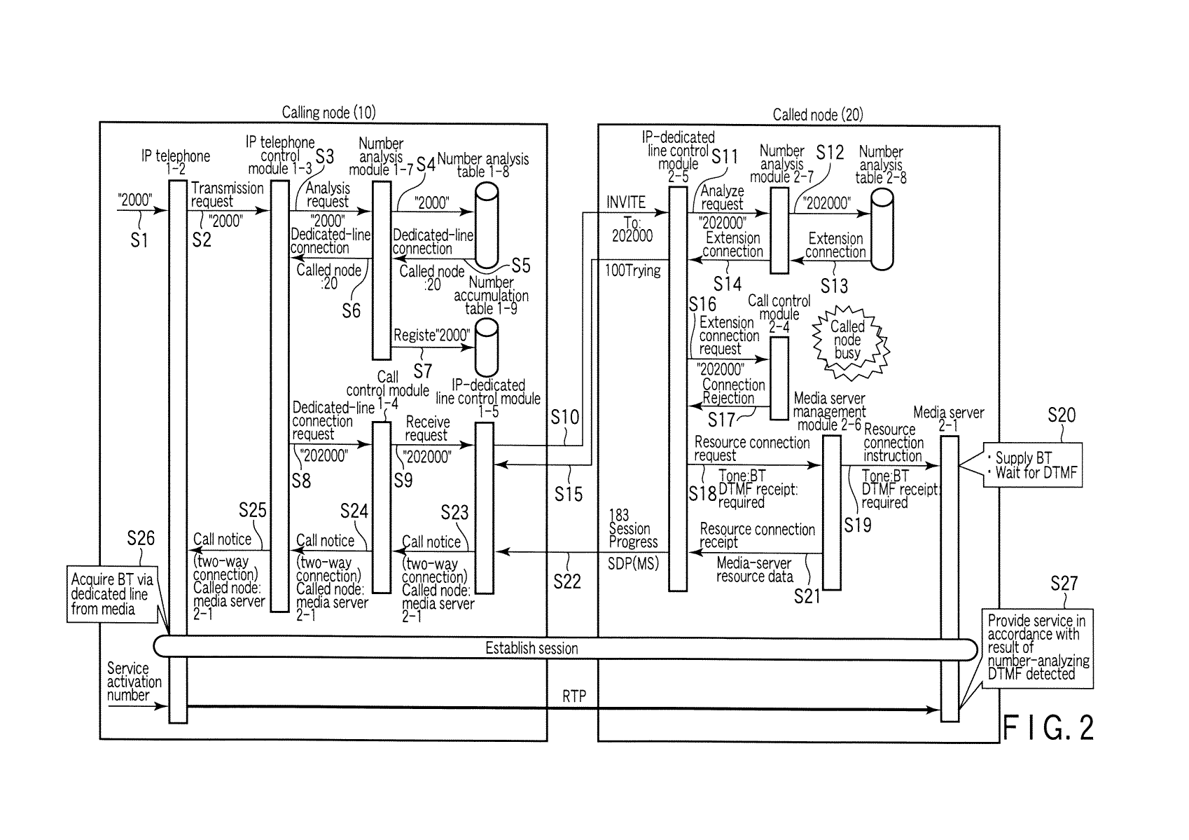

FIG. 2 is a sequence diagram showing the sequence that is performed when resources are abundant at a called node, in order to request resources available in the media server. The protocols that the IP exchange apparatuses can use are session initiation protocol (SIP) and QSIG. The case where SIP is used will be described below.

In any telephone system that uses SIP, each IP telephone sets is registered when the procedure called “log-in” is performed. When an IP telephone set is registered, the extension number, user name, etc. of the IP telephone are registered in the database (i.e., terminal data control table 1-10) in association with the terminal ID of the IP telephone set.

Assume that, as shown in FIG. 2, the IP exchange apparatus 1 of the LAN L1 is a calling node (node number 10) and the IP exchange apparatus 2 of the LAN L2 is a called node (node number 20). The called node (i.e., IP exchange apparatus 2) has function blocks similar to those of the IP exchange apparatus 1 shown in FIG. 1. That is, the called node has an IP telephone control module 2-3, a call control module 2-4, an IP-dedicated line control module 2-5, a media server management module 2-6, a number analysis module 2-7, a number analysis table 2-8, and a number accumulation table 2-9.

When connected to the network, the IP telephone set 1-2 transmits a log-in request to the IP exchange apparatus 1. In the IP exchange apparatus 1, the IP telephone control module 1-3 registers the terminal data representing the IP telephone set 1-2 (i.e., data about the logged-in IP telephone set, such as extension number and IP address) and contained in the log-in request received, in the terminal data control table 1-10.

Assume that the IP telephone set 1-2 connected to the calling node makes a call to the IP telephone set (having number 2000) incorporated in the called node. When the user operates the IP telephone set 1-2, inputting the number “2000” assigned to an IP telephone included in the called node (Block S1), a transmission request containing the number “2000” is transmitted from the IP telephone set 1-2 to the IP telephone control module 1-3 (Block S2). The IP telephone control module 1-3 receives the transmission request, and supplies an analysis request containing the number “2000” to the number analysis module 1-7 (Block S3).

The number analysis module 1-7 refers to the number analysis table 1-8, by using the number “2000” of the called IP telephone, and acquires the number type and node number of the called IP telephone (Block S4). In this instance, the number type acquired is dedicated line connection, and the node number acquired is “20” (Block S5). The number type and node number are notified to the IP telephone control module 1-3 (Block S6). Further, the number “2000” of the called IP telephone set is registered in the number accumulation table 1-9 (Block S7).

The IP telephone control module 1-3 combines the node number “20” and the input dial “2000,” generating a parameter “202000,” in accordance with the analysis made by the number analysis module 1-7. The IP telephone control module 1-3 then transmits a dedicated-line connection request parameter “202000,” as a uniform resource indicator (URI), to the call control module 1-4 (Block S8). Receiving the URI, the call control module 1-4 transmits a receipt request to the IP-dedicated line control module 1-5 (Block S9). On receiving this request, the IP-dedicated line control module 1-5 transmits an INVITE message to the called node 20 (Block S10).

In the called node 20, the IP-dedicated line control module 2-5 receives the INVITE message and supplies the parameter “202000” set in the to the number analysis module 2-7 (Block S11). The number analysis module 2-7 uses “202000” as key, referring to the number analysis table 2-8 (Block S12). The number analysis module 2-7 acquires the number type (extension connect) and the number (i.e., “2000”) of the calling node 10 (Block S13). These data items are supplied from the number analysis module 2-7 to the IP-dedicated line control module 2-5 (Block S14). The IP-dedicated line control module 2-5 transmits 100 Trying back to the calling node 10 (Block S15).

Further, the IP-dedicated line control module 2-5 generates an extension connection request from the data supplied from the number analysis module 2-7. The extension connection request, which contains the dial (2000) of the called node 20 as parameter, is transmitted to the call control module 2-4 (Block S16). At this point, the called terminal 2000 cannot receive the request because it is communicating with any other terminal. In this case, the call control module 2-4 gives a connection rejection to the IP-dedicated line control module (Block S17).

In this state, a busy tone BT must be supplied to the calling node. Hence, a process is started in order to use the resources of the media server. That is, the IP-dedicated line control module 2-5 transmits a resource connection request to the media server management module 2-6 (Block S18), so that a busy tone BT may be supplied to the IP telephone set 1-2 of the calling node 10. The resource connection request contains a parameter (tone type: BT, dual tone multi frequency (DTMF) receipt: required).

The term “resources of the media server” means mainly the logic communication port required in establishing a session between the IP telephone sets. The resources are limited in numbers. The term may further present the concept of data-processing ability of a central processing module (CPU) and the concept of storage capacity.

The media server management module 2-6 first hunts for resource available, which can be used to generate a busy tone and receive a DTMF signal, and then transmits a resource connection instruction (tone type: BT, DTMF reception: required) to the media server 2-1 of the called node 20 (Block S19). On receiving this instruction, the media server 2-1 uses the resource available, supplying a busy tone BT, and then waits for a DTMF signal (Block S20).

The media server management module 2-6 also gives a resource reception notice to the IP-dedicated line control module 2-5 (Block S21). This notice contains the resource data (IP address and port number) about the resource available in the media server 2-1. On receiving this notice, the IP-dedicated line control module 2-5 transmits 183 session progress SDP (MS) to the calling node 10 (Block S22).

In the calling node 10, the IP-dedicated line control module 1-5 receives the 183 session progress SDP (MS) and gives the call control module 1-4 a call notice that demands for two-way connection to the media server 2-1 of the called node 20 (Block S23). This notice arrives at the IP telephone set 1-2 from the call control module 1-4 via the IP telephone control module 1-3 (Blocks S24 and S25). As a result, a session is achieved between the IP telephone set 1-2 of the calling node 10 and the IP telephone set 2-1 of the called node 20, whereby the user of the IP telephone set 1-2 hears the busy tone BT coming from the media server 2-1 (Block S26). Hearing the busy tone, the user can know that the called node is busy.

Note that the IP exchange provides various types of service, such as intra-talk call, talk interruption, and message waiting. If the user of the IP telephone set 1-2 wants to receive any of these types, he or she operates the IP telephone set 1-2, inputting the service activation number assigned to the service.

Then, the IP telephone set 1-2 generates a DTMF signal that is associated with the service activation number. The DTMF signal is transmitted to the media server 2-1 of the called node 20, through the session established. On receiving the DTMF signal via the dedicated network 100, the media server 2-1 requests the number analysis module 2-7 to analyze the contents of the DTMF signal. In accordance with the result of analysis, the IP exchange apparatus 2 activates the service (e.g., intra-talk call, talk interruption, or message waiting) that the called node 20 can provide (Block S27).

In the sequence described above, the media server 2-1 of the called node 20 is abundant in resource. Therefore, the resources of the media server 2-1 are consumed. If the terminal of the called node is busy, the resources available in the media server 2-1 will be used, generating a tone signal. This use of the media server of the called node enables the session to continue through the dedicated network 100.

Hence, if or when the talk at the called node ceases, the media server 2-1 can transmit a ring back tone to the calling node 10. Hearing this tone, the user of the IP telephone set 1-2 of the calling node 10 can know that the talk has ceased.

### Second Embodiment

In the first embodiment, all media servers must be abundant in resource in view of the traffic in the telephone system, so that the sequence described above may be performed. That is, many resources must be provided in each media server, in accordance with how many nodes the system has and how many IP telephone sets are connected to each IP exchange in the system. The more nodes the system has, the higher the resource cost will be. If all communication ports of, for example, the medial server 2-1 of the called node 20 are consumed, the sever 2-1 will be scarce in resource. Consequently, the user can no longer receive service from the media server 2-1. In this case, any tone cannot be transmitted to the IP telephone set 1-2 of the calling node 10. This state is not only inconvenient to the user of the IP telephone set 1-2, but also may cut the call he or she has made. A second embodiment, which can cope with such a state, will be described below.

A process sequence that the second embodiment performs when resources are scarce in a called node will be explained below.

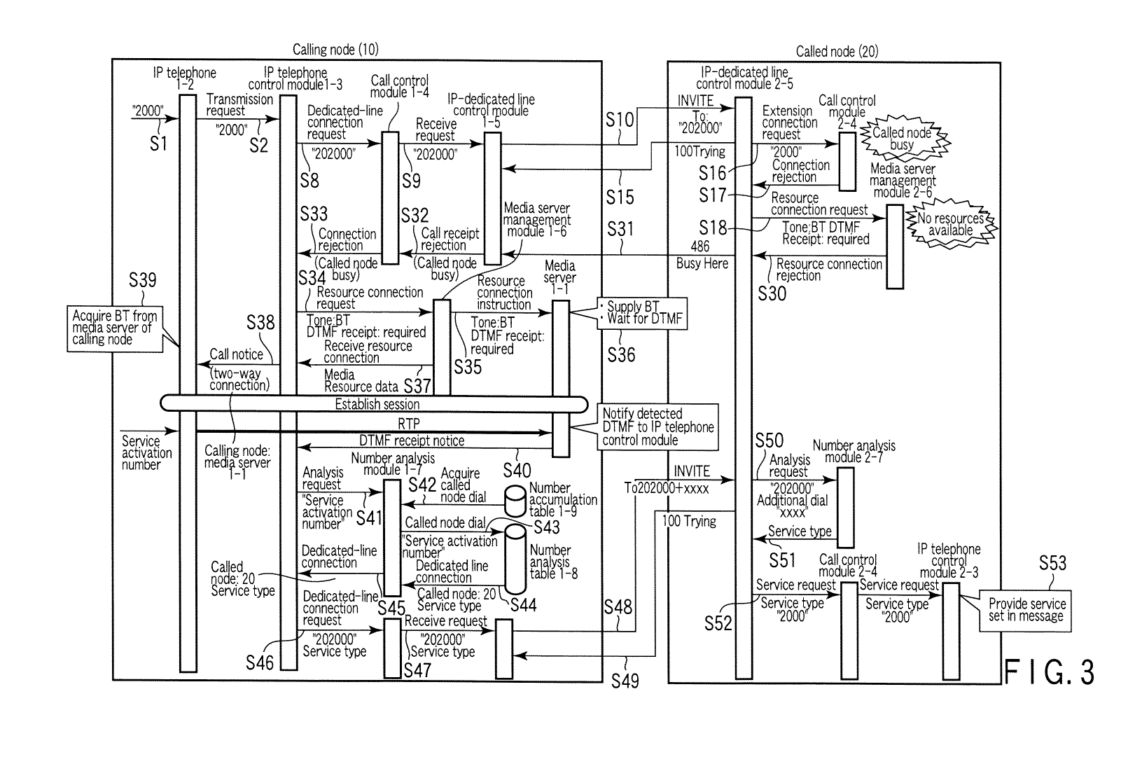

FIG. 3 is a sequence diagram showing the sequence performed when resources are scarce in the called node, in order to request for resources available in the media server of the called node. The sequence of FIG. 3 is designed for the case where the media resources are scarce in the called node. The processes identical to those shown in FIG. 2 are designated by the same block numbers in FIG. 3. Only the processes different from those shown in FIG. 2 will be described. Note that the process the number analysis modules 1-7 and 2-7 perform in the initial phase of the sequence (i.e., Blocks S3 to S7 and Blocks S11 to S14) are similar to those shown in FIG. 2, and will not be described, for simplicity of explanation.

In the called node 20, when the IP-dedicated line control module 2-5 transmits a resource connection request to the media server management module 2-6 in Block S18, the media server management module 2-6 sends a connection rejection to the IP-dedicated line control module 2-5 if no resources are available (Block S30). On receiving the connection rejection, the IP-dedicated line control module 2-5 transmits a 486 Busy Here message to the calling node 10 (Block S31). In the calling node 10, the Receiving this message, the IP-dedicated line control module 1-5 receives this message and transmits the same to the IP telephone control module 1-3 via the call control module 1-4 (Blocks S32 and S33). As a result, no session is established between the calling node 10 and the called node 20.

The 486 Busy Here message is a response made to the INVITE message. Receiving this message, the calling node 10 determines that the called terminal is busy. Therefore, the calling node 10 starts a process of supplying a busy tone BT indicating that the called node is busy, to the IP telephone set 1-2.

That is, in the calling node 10, the IP telephone control module 1-3 transmits a resource connection request (tone type: BT, DTMF reception: required) to the media server management module 1-6 (Block S34). Thus, the resource connection request is processed locally, in the calling node 10, without being transmitted to the dedicated network 100. Receiving this request, the media server management module 1-6 hunts for resources available, and then transmits a resource connection instruction (tone type: BT, DTMF reception: required) to the media server 1-1 (Block S35). On receiving this instruction, the media server 1-1 uses the resource acquired, supplying a busy tone BT, and then waits for a DTMF signal (Block S36).

The media server management module 1-6 gives a resource reception notice to the IP telephone control module 1-3 (Block S37). This notice contains the resource data (IP address and port number) about the resource available in the media server 1-1. On receiving this notice, the IP telephone control module 1-3 transmits a call notice to the IP telephone set 1-2 (Block S38). A session is thereby established between the IP telephone 1-2 and the media server 1-1. The user of the IP telephone set 1-2 can therefore hear the busy tone BT generated in the media server 1-1 (Block S39). That is, the IP telephone set 1-2 has received the busy tone BT from the media server 1-1 that is connected to the calling node 10. Hearing this busy tone, the user recognizes that the called node is busy.

Available as types of standard service provided by the IP exchange are: intra-talk call, talk interruption, and message waiting. If the user of the IP telephone set 1-2 wants to receive service, such as intra-talk call, talk interruption or message waiting, he or she operates the IP telephone set 1-2, inputting the service activation number assigned the service, while hearing the busy tone BT. Then, the media server 1-1 locally receives DTMF and notifies the receipt of DTMF to the IP telephone control module 1-3 of the calling node 10 (Block S40). The IP telephone control module 1-3 requests the number analysis modules 1-7 to analyze the contents of DTMF (Block S41).

The number analysis modules 1-7 acquires the number “2000” of the called node 20, which is registered in the number accumulation table 1-9 (Block S42), then refers to the number analysis table 1-8, by using the service activation number as key (Block 43). The service requested for is thereby identified (Block S44). The number analysis modules 1-7 then informs the IP-dedicated line control module 1-3 of the type of service, thus identified, and the called node number (20) (Block S45).

Then, the IP telephone control module 1-3 transmits a dedicated-line connection request to the call control module 1-4 (Block S46). The dedicated-line connection request is composed of the service-type data and parameter “202000,” i.e., a combination of the number (20) of the called node 20 and the input dial “2000.” On receiving this request, the call control module 1-4 transmits a receipt request to the IP-dedicated line control module 1-5 (Block S47). Receiving this request, the IP-dedicated line control module 1-5 transmits an INVITE message to the called node 20 (Block S48). This message contains the parameter “202000” and an additional dial “xxxx.” The additional dial is the service activation number that has been input.

In the called node 20, the IP-dedicated line control module 2-5 transmits a 100 Trying message to the calling node 10 (Block S49), then informs the number analysis module 2-7 of the parameter “202000” and the additional dial “xxxx,” both contained in the INVITE message (Block S50). The IP-dedicated line control module 2-5 therefore acquires the type of service (Block S51). The IP-dedicated line control module 2-5 sets the type of service to the parameter, requesting the call control module 2-4 to activate the service (Block S52). As a result, the service (e.g., intra-talk call, talk interruption, or message waiting) is activated (Block S53).

As explained above, in the telephone system according to the second embodiment, wherein the resources of a media server are used to provide various types of services, the call control message is switched, from one to another, in accordance with the resources still available in the media server. In other words, the media server for providing service is switched for each call made. Moreover, if an IP telephone of the calling node is connected to the media server of the called node, the dial input at the IP telephone set of the calling node is analyzed, and the call control message to the called node is transmitted in accordance with the result of analysis. Whichever resource of the media server of the called node is utilized, the IP telephone set of the calling node can receive the service corresponding to the resource utilized.

Hence, the cost of the resources in the media servers connected to all IP exchange apparatuses constituting the IP network system can be lowered, and the equivalent IP exchange service can yet be always provided to any IP telephone sets on the same network. The second embodiment can therefore provide a telephone system capable of providing sufficient service to IP telephone sets, while suppressing the cost of the resources in the media servers, and telephone exchange apparatuses for use in this system.

The embodiment is not limited to the embodiments described above. For example, the tone signal supplied from the media server may not be a busy tone BT. It may, instead, be a re-order tone, a fast-busy tone, or the like.

The re-order tone is transmitted if a wrong number is dialed at a calling terminal, calling a non-existent terminal, or if a trouble occurs in the called terminal and no service cannot be activated in spite of the calling. The fast-busy tone is transmitted if the number dialed at the calling terminal is assigned to a terminal that rejects the call.

As described above, the embodiments cope with the case where resources are scarce in the media server of any called node. Moreover, a resource-connection rejection may be transmitted if the among of remaining resources is half or less the initially amount (in Block S30 shown in FIG. 3). In other words, it may be determined that resources are no longer available, if the amount of resources available in the media server is less than a threshold value.

### Third Embodiment

A third embodiment will be described. In this embodiment, each IP telephone set has the function of transmitting a tone signal such as a busy tone. Since any IP telephone set of the called node has this function, the user of the calling IP telephone set can hear the busy tone even if the resources available in the media server of the calling node are not utilized at all.

Whether any IP telephone set of the calling node has the function of transmitting a tone signal is determined in the present embodiment. Further, this embodiment is based on the assumption that the resources of the media server of the called node are scarce.

In this embodiment, terminal data showing whether the calling node has the function of transmitting a tone signal is supplied to the server, thereby to register the IP telephone set is logged in. The server stores the data showing whether a circuit for generating a tone exists or not, in a terminal data management table in which to register the terminal data about of each IP telephone set.

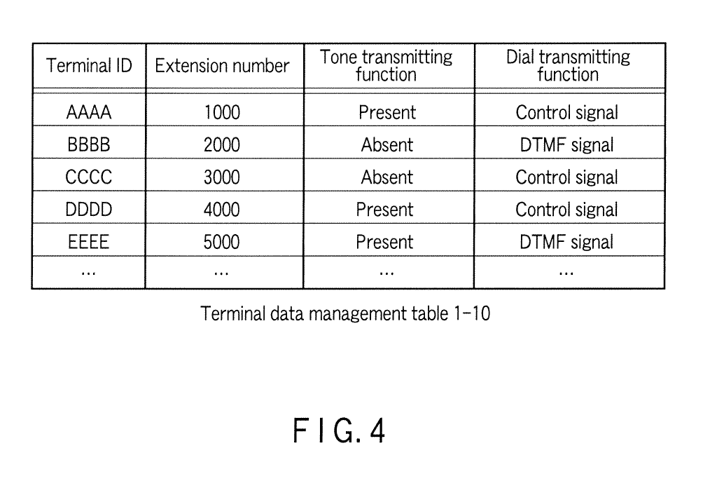

FIG. 4 is a diagram showing exemplary contents that may be registered in the terminal data management table 1-10. This table is stored in, for example, each IP exchange apparatus, and holds tone-transmitting function presence/absence data and the details of a dial transmitting function, for any IP telephone set connected to the IP exchange apparatus. Any calling IP telephone set that has the tone transmitting function can transmit a tone signal to the called IP telephone set. The dial transmitting function transmits either a “control signal” or a “DTMF signal.” The control signal or the DTMF signal is an instruction made to the called IP telephone set.

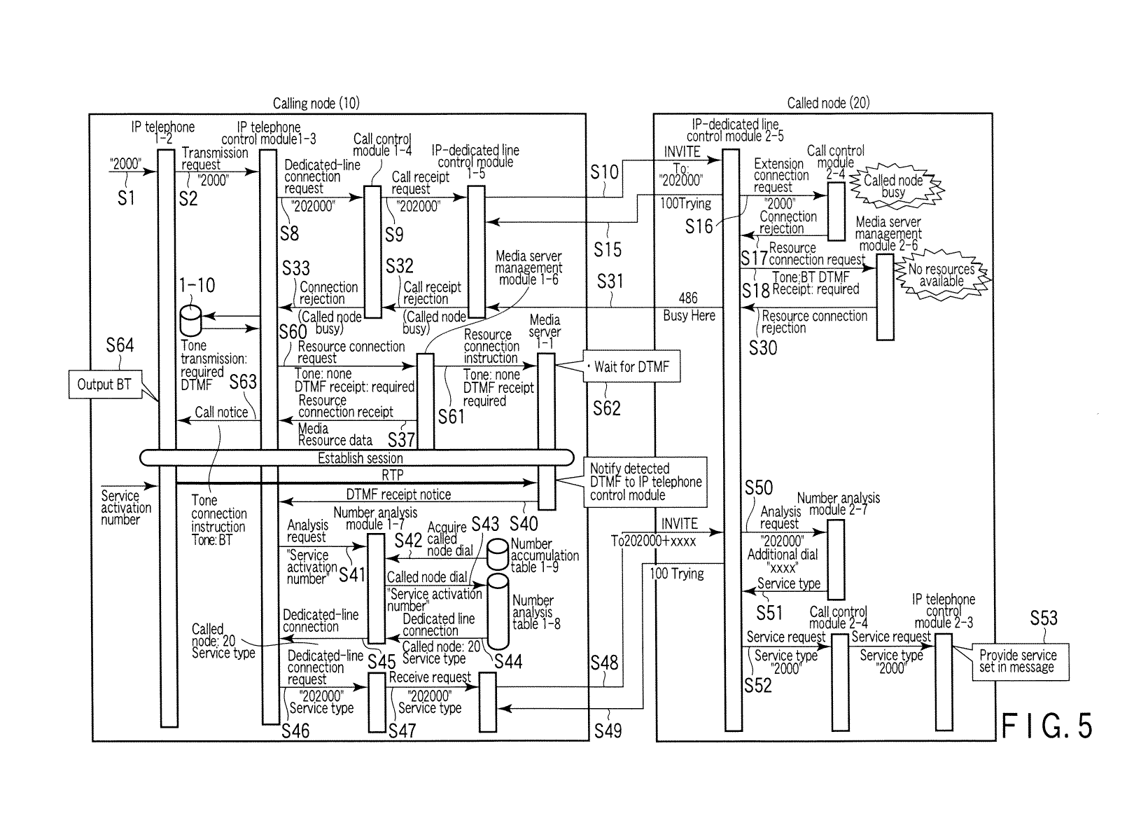

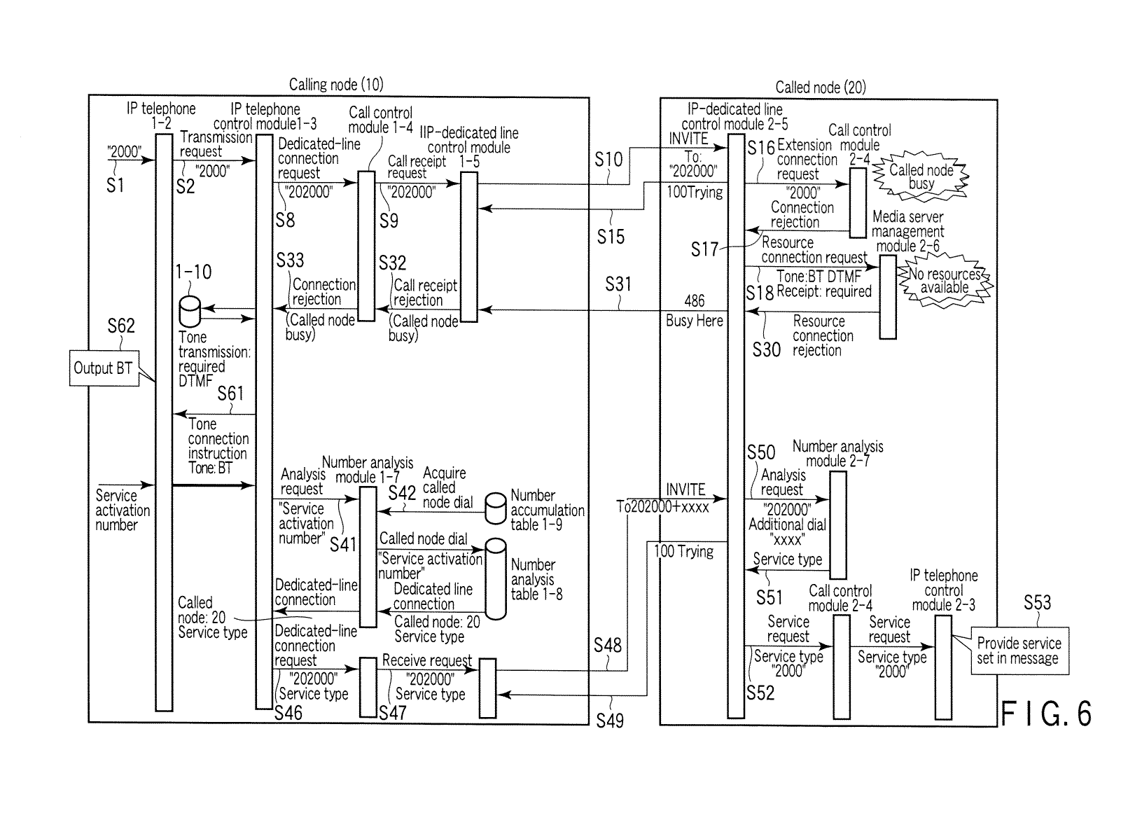

FIG. 5 is a sequence diagram showing the sequence performed if the calling IP telephone set includes the dial transmitting function and the dial transmitting function transmits a DTMF signal. In FIG. 5, the blocks identical to those shown in FIG. 6 are designated by the same numbers. Only the blocks different from those shown in FIG. 6 will be explained. Here, whether any IP telephone set of the calling node has the function of transmitting a tone signal is determined, and it is assumed that the resources of the media server of the called node are scarce. Note that the resource for outputting a tone is assigned to the session undergoing at present, if the called IP telephone set is busy, through having the function of transmitting a tone signal.

In the calling node 10, the IP telephone control module 1-3, which has received a 486 Busy Here message in Block S33 (FIG. 5), refers to the terminal data management table 1-10. If the calling IP telephone has the tone transmitting function and if the dial transmitting function is DTMF, the IP-dedicated line control module 1-3 transmits a resource connection instruction (tone: none, DIME reception: required) to the media server management module 1-6 (Block S60). Receiving this request, the media server management module 1-6 hunts for resources available, and then transmits a resource connection instruction (tone type: none, DTMF reception: required) to the media server 1-1 (Block S61). On receiving this instruction, the media server 1-1 uses the resource acquired, and starts waiting for DTMF (Block S62).

The media server management module 1-6 gives a resource reception notice to the IP-dedicated line control module 1-3 (Block S37). This notice contains the IP telephone control module 1-3 (IP address and port number) about the resource available in the media server 1-1.

On receiving this notice, the IP telephone control module 1-3 transmits a call notice and a tone connection instruction (tone: BT) to the IP telephone set 1-2 (Block S63). The call notice two-way connection. Receiving the call notice and the tone connection instruction, the IP telephone set 1-2 generates and output a busy tone BT. More precisely, the tone generating circuit incorporated in the IP telephone set 1-2 generates the busy tone (Block S64), which the user of the IP telephone set 1-2 can hear. Hearing this busy tone, the user recognizes that the called node is busy.

A session is established between the IP telephone set 1-2 and the media server 1-1. Therefore, if the user of the IP telephone set 1-2 wants to receive service, such as intra-talk call, talk interruption or message waiting, he or she operates the IP telephone set 1-2, inputting the service activation number assigned the service, while hearing the busy tone BT. Then, the media server 1-1 locally receives DTMF and notifies the receipt of DTMF to the IP telephone control module 1-3 of the calling node 10 (Block S40). Thereafter, a similar operation is performed.

The sequence described above indeed requires resources to receive a DTMF signal. However, no resources stored in the media server need to be used to generate a tone signal. This can reduce the consumption of the resources of the media server.

FIG. 6 is a sequence diagram showing a different sequence that may be performed if the calling IP telephone set includes the function of transmitting a tone signal and if the dial transmitting function is performed by using a control signal. In this sequence, the IP telephone control module 1-3 of the calling node 10 receives a resource-connection rejection (Block S33, FIG. 6), and refers to the terminal data management table 1-10. If the calling IP telephone set includes the tone transmitting function and if the dial transmitting function is achieved by a control signal, the IP telephone control module 1-3 immediately transmits a tone connection instruction (tone: BT) to the IP telephone set 1-2 (Block S61). Receiving this instruction, the IP telephone set 1-2 generates and outputs a busy tone BT (Block S62).

Further, the dial transmitting function can output a control signal. Hence, if the user inputs, at the of the IP telephone set 1-2, a service activation number for any service wanted, the IP telephone set 1-2 converts this number not to a tone signal, but to a control signal for activating the service. The control signal is input to the IP telephone control module 1-3. Hence, the contents of the service the IP telephone control module 1-3 has demanded can be recognized, without using the resources of the media server.

The IP telephone of the calling node therefore includes the function of generating a tone and can transmit a control signal, performing the dial transmitting function. The IP telephone set 1-2 of the calling node can therefore generates a tone signal and can input a control signal in order to activate the service designated. Therefore, the resources of the media server are not consumed.

### Fourth Embodiment

A fourth embodiment will be described. In this embodiment, priority degrees are set to the IP telephone sets, respectively, and whether the resources available in the media server of the called node should be acquired or not is determined in accordance with the priority degree set to any IP telephone set of the calling node. The priority degrees can be so set that, for example, the higher the rank of an employee of a company, the higher the priority degree his or her IP telephone set will have. Alternatively, a high priority degree can be assigned to the IP telephone sets used in a department, while a lower priority degree to the IP telephone sets used in another department. Still alternatively, a high priority degree can be assigned to the IP telephone sets used in a particular department.

More precisely, the resources available in the media server of the called node should be used, but are limited in amount. In view of this, when the terminals are logged in, different priority degrees assigned to the IP telephone sets are registered, as terminal data, in the terminal data management table 1-10. When a call is made at an IP telephone set, the priority degree of the IP telephone set is determined in the initial phase of the sequence. If the priority degree is high, the resources available in the media server of the called node may be used. If the priority degree is low, the resources available in the media server of the calling node may be used.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A telephone system in which a plurality of nodes connected by a communication network, each node including an exchange apparatus incorporating telephone terminals and a media server configured to generate a tone signal,
the exchange apparatus comprising:
a detector configured to detect an amount of resources remaining in the media server of the node including the exchange apparatus; and
a controller configured to transmit a tone signal to a telephone terminal of a calling node from the resources available in the media server of the node including the exchange apparatus, which is a called node, in response to a call connection request made from the calling node to the exchange apparatus if the amount of resources remaining in the media server of the called node exceeds a prescribed threshold value.

2. The telephone system of claim 1, wherein the exchange apparatus comprises:
a transmitter configured to transmit a transmission request from the telephone terminal of the called node to any other node through the communication network;
a receiver configured to receive a transmission request transmitted from the other node to the called node;
a signal transmission module configured to transmit a resource request signal to the calling node demanding the resources available in the media server of the calling node, if the amount of resources remaining in the media server of the called node is equal to or less than a prescribed threshold value, in response to the transmission request; and
a session forming module configured to form a session between a calling telephone terminal of the called node and the media server of called node and to supply a tone signal from the media server to the telephone terminal of the calling node, in receiving the message.

3. The telephone system of claim 2, wherein the exchange apparatus further comprises:
a memory configured to store a dial number input at the telephone terminal of the called node; and
a service demanding module configured to add a number to the dial number stored in the memory when the number requesting for a specific service is input from the telephone terminal of the calling node, and to request a node associated with the number to provide the specific server.

4. The telephone system of claim 3, wherein the exchange apparatus further comprises a terminal data management table configured to register the functions of each of the telephone terminals, and the session formation module determines whether the telephone terminal of the calling node has a function of transmitting the tone signal to make a call and transmits a tone-generation requesting signal to the telephone terminal of the calling node if the telephone terminal of the calling node includes the function of transmitting the tone signal.

5. The telephone system of claim 1, wherein the telephone terminals include different priority degrees, respectively, and the exchange apparatus determines whether the resources available in the media server of the called node or the resources available in the media server of the calling node should be used, based on the priority degrees when a tone signal is transmitted to the telephone terminal of the calling node.

6. An exchange apparatus for use in a telephone system in which a plurality of nodes connected by a communication network, each node having an exchange incorporating telephone terminals and a media server configured to generate a tone signal, the exchange apparatus comprising:
a detector configured to detect an amount of resources remaining in the media server of the node including the exchange apparatus; and
a controller configured to transmit a tone signal to a telephone terminal of a calling node from the resources available in the media server of the node including the exchange apparatus, which is a called node, in response to a call connection request made from the calling node to the exchange apparatus if the amount of resources remaining in the media server of the called node exceeds a prescribed threshold value.

7. The exchange apparatus of claim 6, further comprising:
a transmitter configured to transmit a transmission request from the telephone terminal of the called node to any other node through the communication network;
a receiver configured to receive a transmission request transmitted from the other node to the called node;
a signal transmission module configured to transmit a resource request signal to the calling node demanding the resources available in the media server of the calling node, if the amount of resources remaining in the media server of the called node is equal to or less than a prescribed threshold value, in response to the transmission request; and
a session forming module configured to form a session between a calling telephone terminal of the called node and the media server of called node and to supply a tone signal from the media server to the telephone terminal of the calling node, in receiving the message.

8. The exchange apparatus of claim 6, further comprising:
a memory configured to store a dial number input at the telephone terminal of the called node; and
a service demanding module configured to add a number to the dial number stored in the memory when the number requesting for a specific service is input from the telephone terminal of the calling node, and to request a node associated with the number to provide the specific server.

9. The exchange apparatus of claim 8, which further comprises a terminal data management table configured to register the functions of each of the telephone terminals, and in which the session formation module determines whether the telephone terminal of the calling node includes a function of transmitting the tone signal to make a call and transmits a tone-generation requesting signal to the telephone terminal of the calling node if the telephone terminal of the calling node includes the function of transmitting the tone signal.

10. The exchange apparatus of claim 6, wherein if the telephone terminals have different priority degrees, respectively, the exchange apparatus determines whether the resources available in the media server of the called node or the resources available in the media server of the calling node should be used, based on the priority degrees when a tone signal is transmitted to the telephone terminal of the calling node.
